(19) United States
(12) Patent Application Publication
(10) Pub. No.: US 2003/0078307 A1
(43) Pub. Date: Apr. 24, 2003

(54) Water-soluble surfactant compositions

(76) Inventors: Shuichiro Shinohara, Takefu-shi (JP); Toru Mizusaki, Takefu-shi (JP); Norio Nakamura, Takefu-shi (JP)

Correspondence Address: BIRCH STEWART KOLASCH & BIRCH, PO BOX 747, FALLS CHURCH, VA, 22040-0747, US

(21) Appl. No.: 10/157,081

(22) Filed: May 30, 2002

(30) Foreign Application Priority Data
May 30, 2001 (JP) 2001-163378

(51) Int. Cl. C09K 3/00

(52) U.S. Cl. 516/113

(57) ABSTRACT

Water-soluble surfactant compositions comprising (A) 2,5,8,11-tetramethyl-6-dodecyne-5,8-diol and/or ethoxylate thereof and (B) a polyoxy(ethylene-propylene) block polymer and exhibiting a dynamic surface tension of up to 50 mN/m both at 1 Hz and 10 Hz in a 0.1 wt % aqueous solution thereof have such surface tension-reducing effects that when added to inks and paper coatings, they provide a surface tension comparable to those of fluorochemical and silicone surfactants. Because of a low dynamic surface tension, the surfactant compositions develop excellent substrate wetting, substrate penetrating and anti-foaming capabilities to comply with high-speed printing and coating, and overcome the environmental problem.

This invention relates to water-soluble surfactant compositions and more particularly, to water-soluble surfactant compositions having a surface tension-reducing capability comparable to fluorochemical and silicone surfactants when added to water-based inks and paper coatings, having a sufficiently low dynamic surface tension to develop excellent wetting, penetrating and anti-foaming capabilities to comply with high-speed printing and coating, and clearing the environmental problem of the current concern.

### BACKGROUND OF THE INVENTION

Partly because of the environmental problem which is now of great concern, the printing, paper-making and coating industries are making a transition to aqueous systems. Since the aqueous systems are low in manufacturing speed than solvent systems because of slow drying speeds, the requirement for high-speed processing essential for efficient production is always imposed on the aqueous systems. It is demanded to improve the performance of inks and paper coatings so as to comply with high-speed printing and coating. The current trend of diversifying substrates to be printed has brought the development of polyolefin substrates as a substitute for vinyl chloride substrates. The polyolefin substrates are difficult to print or coat since they tend to shed aqueous inks and coatings.

Under such circumstances, the aqueous ink and aqueous paint industries need surfactants having a surface tension-reducing capability in order to acquire a wetting or penetrating ability to substrates. Fluorochemical surfactants and silicone surfactants are being introduced which can achieve a significant reduction of surface tension when added only in small amounts. These surfactants can significantly reduce static surface tension, but not dynamic surface tension, allowing repellent problems to arise in the coating process which is currently carried out at high speeds.

It is known in the art that acetylene glycol surfactants such as 2,5,8,11-tetramethyl-6-dodecyne-5,8-diol and ethylene oxide derivatives thereof have a good balance of static and dynamic surface tension-reducing capabilities and are substantially free from the negative characteristics of the prior art fluorochemical and silicone surfactants. Owing to an additional anti-foaming capability, they are useful as the wetting agent and dispersing aids for inks and paints.

However, the acetylene glycol surfactants have a very low solubility in water and are not substantially dissolved when added to aqueous inks or emulsions. They fail to achieve the desired effects when combined with aqueous inks and paints. JP-A 6-182176 discloses blends of 2,5,8,11-tetramethyl-6-dodecyne-5,8-diol with succinate surfactants. These blends where the succinate surfactants are used as a solubilizing agent have a good surface tension-reducing capability, but raise problems including potential uneven coating due to bubbles generated during blending. Since the succinate surfactants are anionic, the ionic nature of paint to which they are added is limited.

In consideration of the environmental and safety problems which are now of great concern, there is a tendency of interrupting the manufacture of fluorochemical surfactants. The use of silicone surfactants is banned or limited in some applications. There is an increasing demand for alcoholic surfactants capable of significantly reducing both static and dynamic surface tensions even when added in small amounts.

### SUMMARY OF THE INVENTION

An object of the invention is to provide a water-soluble surfactant composition which has sufficiently low dynamic and static surface tensions to develop excellent wetting and penetrating capabilities to a variety of substrates used in printing and coating as well as a foam suppressing capability, is self-emulsifiable in water so that it is ready for use, and is free of fluorine and silicone.

We have found that a surfactant composition comprising in admixture, an acetylene glycol surfactant of the formula (1) and/or (2) shown below and a polyoxy(ethylene-propylene) block polymer having a specific molar number of ethylene oxide added and a specific molecular weight is useful as an additive to aqueous inks and paper coatings. This surfactant composition is ready for use because of its ability to self-emulsify in water, provides excellent wetting, penetrating and anti-foaming capabilities because of its very low dynamic and static surface tensions, and clears the environmental problem. That is, the surfactant composition has overcome the above-discussed problems of the prior art.

The present invention provides a water-soluble surfactant composition comprising

(A) 10 to 95% by weight of an acetylene glycol of the following formula (1):

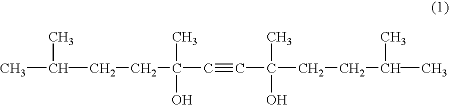

and/or an acetylene glycol ethoxylate of the following formula (2):

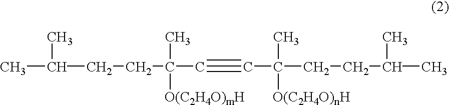

wherein m and n are positive numbers and the sum of m+n is from 2 to 30, and

(B) 5 to 90% by weight of at least one polymer selected from polyoxy(ethylene-propylene) block polymers of the following formula (3):

HO(C₂H₄O)_{w}(C₃H₆O)ₓ(C₂H₄O)_{y}H (3)

wherein w, x and y are positive numbers, having a weight average molecular weight of 1,500 to 10,000, an ethylene oxide content of 35 to 90% by weight and a propylene oxide content of 10 to 65% by weight. The composition exhibits a dynamic surface tension of up to 50 mN/m both at 1 Hz and 10 Hz in a 0.1 wt % aqueous solution thereof.

### DESCRIPTION OF THE PREFERRED EMBODIMENTS

Component (A) in the water-soluble surfactant composition of the invention is at least one acetylene glycol selected from 2,5,8,11-tetramethyl-6-dodecyne-5,8-diol having the following formula (1) and ethylene oxide derivatives of 2,5,8,11-tetramethyl-6-dodecyne-5,8-diol having the following formula (2).

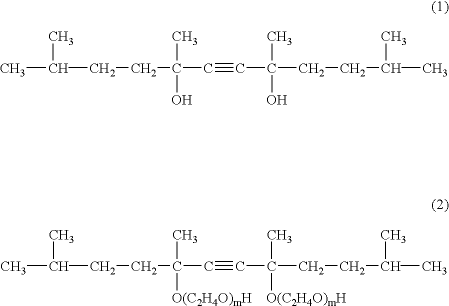

Herein m and n are positive numbers and the sum of m+n is from 2 to 30, and preferably from 4 to 12.

In the ethoxylate represented by formula (2), the total molar number of ethylene oxide added is 2 to 30 moles, and preferably 4 to 12 moles. If the total molar number of ethylene oxide added exceeds 30 moles, then the ethoxylate has increased static and dynamic surface tensions, losing the wetting function.

These acetylene glycols (A) may be used alone or in admixture of two or more and are used in an amount of 10 to 95% by weight, preferably 40 to 70% by weight when the water-soluble surfactant composition according to the invention is prepared. Compositions containing less than 10% by weight of the acetylene glycol have a dynamic surface tension high enough to cause repellency during high-speed printing. Compositions containing more than 95% by weight of the acetylene glycol are less dissolvable in water so that they form agglomerates when added to water, fail to achieve the surface tension-reducing effect, thus causing repellency, and substantially lose stability during low-temperature storage, with the resultant difficulty of blending.

Component (B) to be admixed with the acetylene glycol (A) is a polyoxy(ethylene-propylene) block polymer having the following formula (3):

HO(C₂H₄O)_{w}(C₃H₆O)ₓ(C₂H₄O)_{y}H (3)

wherein w, x and y are positive numbers. Illustrative examples include

HO(C₂H₄O)_{w}(C₃H₆O)₂₀(C₂H₄O)_{y}H wherein w+y=27,

HO(C₂H₄O)_{w}(C₃H₆O)₃₀(C₂H₄O)_{y}H wherein w+y=160,

HO(C₂H₄O)_{w}(C₃H₆O)₃₅(C₂H₄O)_{y}H wherein w+y=30,

HO(C₂H₄O)_{w}(C₃H₆O)₃₅(C₂H₄O)_{y}H wherein w+y=48, and

HO(C₂H₄O)_{w}(C₃H₆O)₂₀(C₂H₄O)_{y}H wherein w+y=155.

These block polymers may be used alone or in admixture of two or more.

The block polymer (B) should have a weight average molecular weight (Mw) of 1,500 to 10,000, and preferably 3,000 to 9,000. A block polymer with Mw<1,500 has a reduced solubilizing capability and a reduced solubility in water so that it may form insolubles when blended in ink. With Mw>10,000, a high dynamic surface tension can cause bleeding upon printing.

The block polymer (B) should have an ethylene oxide content of 35 to 90% by weight and preferably 35 to 85% by weight. With an ethylene oxide content of less than 35 wt %, a reduced solubilizing power can cause agglomerate formation. An ethylene oxide content of more than 90 wt % increases not only the solubilizing power, but also the dynamic surface tension, causing repellency during high-speed coating.

The block polymer (B) should also have a propylene oxide content of 10 to 65% by weight, preferably 15 to 65% by weight, and more preferably 30 to 60% by weight.

In preparing the water-soluble surfactant composition according to the invention, the block polymer (B) is used in an amount of 5 to 90% by weight, preferably 5 to 50% by weight. Less than 5% of component (B) fails to fully solubilize component (A), so that the composition may have a low water solubility and form agglomerates when blended. More than 90% of component (B) gives a composition which is more foamy upon blending and has a high dynamic surface tension causing uneven coating or repellency.

In the practice of the invention, it is preferred that components (A) and (B) be used in such amounts as to give a total 100% by weight. If desired, a third component, referred to component (C) hereinafter, may be included in the surfactant composition. Illustrative examples of component (C) include deionized water; water-soluble organic solvents such as ethylene glycol, diethylene glycol, triethylene glycol, tetraethylene glycol, polyethylene glycol, propylene glycol, dipropylene glycol, 1,3-propane diol, 1,4-butane diol and glycerin; and acetylene glycols and ethoxylates thereof, other than those of formulae (1) and (2), such as, for example, 5,8-dimethyl-6-dodecyne-5,8-diol, 2,4,7,9-tetramethyl-5-decyne-4,7-diol, 2,4,7,9-tetramethyl-5-decyne-4,7-diol ethoxylate (ethylene oxide added 4 moles), 2,4,7,9-tetramethyl-5-decyne-4,7-diol ethoxylate (ethylene oxide added 10 moles), 2,4,7,9-tetramethyl-5-decyne-4,7-diol ethoxylate (ethylene oxide added 30 moles), 4,7-dimethyl-5-decyne-4,7-diol, 8-hexadecyne-7,10-diol, 7-tetradecyne-6,9-diol, 2,3,6,7-tetramethyl-4-octyne-3,6-diol, 3,6-diethyl-4-octyne-3,6-diol, 3,6-dimethyl-4-octyne-3,6-diol, and 2,5-dimethyl-3-hexyne-2,5-diol. Component (C) may be used in an amount of 0 to 25%, and preferably 10 to 20% by weight of the surfactant composition as long as this does not detract from the desirable properties of the surfactant composition.

The water-soluble surfactant composition of the invention is prepared by any well-known mixing method, for example, by mixing the above-described components in a propeller mixer. If any component is solid at room temperature, the mixing is carried out under optional heating.

The resulting water-soluble surfactant composition should exhibit a dynamic surface tension of up to 50 mN/m, preferably 10 to 50 mN/m, and more preferably 25 to 40 mN/m, in a 0.1 wt % aqueous solution thereof. The dynamic surface tension of a 0.1 wt % aqueous solution of the surfactant composition is measured at a frequency of 1 Hz and 10 Hz, using a bubble pressure type dynamic surface tensiometer KRUSS BP-2 by KRUSS GmbH. If the dynamic surface tensions of a 0.1 wt % aqueous solution of the surfactant composition at 1 Hz and 10 Hz exceed 50 mN/m, bleeding can occur, due to repellency and shortage of penetrating power, in printing or coating operation on a printing or coating machine, although no repellency is ascertained upon brush coating or bar coater application.

When the water-soluble surfactant composition of the invention is used to prepare an aqueous ink or as an aqueous wetting agent to prepare a paper coating, the surfactant composition is preferably added in an amount of 0.05 to 10%, and more preferably 0.05 to 5% by weight based on the total weight of the ink or paper coating.

### EXAMPLE

Examples of the invention are given below by way of illustration and not by way of limitation. All parts and percents are by weight.

### Example 1

40 parts of 2,5,8,11-tetramethyl-6-dodecyne-5,8-diol was admitted into a vessel equipped with a propeller mixer. With agitating, 60 parts of polyoxy(ethylene-propylene) block polymer (trade name Epan 750 by Dai-ichi Kogyo Seiyaku Co., Ltd.) was slowly added and mixed. After 2 hours of continuous agitation, the mixture was cooled to room temperature. Thereafter, it was passed through a 200-mesh filter fabric, obtaining a surfactant composition, designated M1.

Surfactant composition M1, 0.1 part, was added to 100 parts of deionized water, which was stirred by a magnetic stirrer to form a 0.1% aqueous solution. The outer appearance, dynamic surface tension and static surface tension of this aqueous solution were measured, with the results shown in Table 2.

Using surfactant composition M1, an ink preparation (Ink 1) and a paper coating (Coat 1) were prepared according to the formulation shown below. The ink preparation was examined for printability (printing plate etching depth), with the results shown in Table 3. The paper coating was examined for repellency and foamability, with the results also shown in Table 3.

Ink Formulation

An aqueous vehicle was prepared by blending 56 parts of an emulsion for aqueous ink (VINYBLAN 620, solids content 45%, Nissin Chemical Industry Co., Ltd.) with 25 parts of deionized water, 14 parts of ethyl alcohol and 5 parts of 25% aqueous ammonia. With stirring, 7 parts of deionized water and 15 parts of organic pigment Chromo Fine Blue 5165 (phthalocyanine blue by Dainichi Seika Co., Ltd.) were slowly added to 78 parts of the aqueous vehicle, after which 1 part of surfactant composition M1 was added. Mixing for one hour yielded an ink preparation (Ink 1).

Paper Coating

To 100 parts of an emulsion for paper coat (VINYBLAN 2750, solids content 44%, Nissin Chemical Industry Co., Ltd.) was added 1 part of surfactant composition M1. This was agitated for 30 minutes in a propeller mixer, obtaining a paper coating (Coat 1).

The test methods employed for examining the properties are described below.

Evaluation of Aqueous Solution of Surfactant Composition

1) Outer Appearance of Aqueous Solution

The outer appearance of the aqueous solution was observed as well as the presence of insolubles.

∘: aqueous solution is clear, with no insolubles found

Δ: aqueous solution is white turbid, but no insolubles found

×: some insolubles found

××: little dissolved

2) Dynamic Surface Tension

Using a bubble-pressure type dynamic surface tensiometer KRUSS BP-2 by KRUSS GmbH, the dynamic surface tension of a 0.1% aqueous solution of the surfactant composition at 1 Hz and 10 Hz was measured.

3) Static Surface Tension

Using a surface tensiometer ESB-V by Kyowa Interface Science Co., Ltd., the static surface tension of a 0.1% aqueous solution of the surfactant composition was measured.

Evaluation of Ink Preparation

1) Printability

In a printability tester GRAVO-PROOF by Nissho Gravure Co., Ltd., a roll which had been etched to a varying plate depth in the range of 10 to 100% was mounted. By applying an ink preparation to the roll at a speed of 50 m/min, the printable plate depth was determined. An ink preparation enabling printing at an etching depth of 30% or less is judged to have good printability.

Evaluation of Paper Coating

1) Repellency

Using the printability tester GRAVO-PROOF by Nissho Gravure Co., Ltd., the paper coating was applied at a speed of 50 m/min. Repellency on the coated surface was visually observed.

∘: no repellency or pinholes

Δ: some repellency and pinholes

×: more repellency and pinholes

2) Foaming

The paper coating was diluted with water in a coating/water ratio of 1/2. This sample, 20 ml, was contained in a 100-ml measuring cylinder, which was shaken for one minute by a shaker at 180 strokes/min. At the end of shaking, the sample was allowed to stand for 5 minutes. The volume (ml) of foams was measured.

### Examples 2-5 & Comparative Examples 1-6

As in Example 1, surfactant compositions M2 to M11 were prepared by agitating and mixing the components, the type and amount of which are shown in Table 1. The type and amount of components used in Example 1 are also shown in Table 1.

As in Example 1, 0.1% aqueous solutions of the surfactant compositions were prepared and tested. The results are shown in Table 2. As in Example 1, ink preparations and paper coatings were prepared and tested. The results are shown in Table 3.

TABLE 1

| | Example | | | | | Comparative Example | | | | | |
|---|---|---|---|---|---|---|---|---|---|---|---|
| | 1 | 2 | 3 | 4 | 5 | 1 | 2 | 3 | 4 | 5 | 6 |
| Surfactant composition | M-1 | M-2 | M-3 | M-4 | M-5 | M-6 | M-7 | M-8 | M-9 | M-10 | M-11 |
| (Component content, wt%) | | | | | | | | | | | |
| Component A | | | | | | | | | | | |
| A-1 | 40 | | 20 | | 15 | 30 | 7 | | 35 | | |
| A-2 | | 75 | 45 | 65 | 50 | 67 | | 50 | | | 100 |
| A-3 | | | | | | | | | | 45 | |
| Component B | | | | | | | | | | | |
| B-1 | 60 | | | | | 3 | | | | 45 | |
| B-2 | | 10 | | | 25 | | | | | | |
| B-3 | | | 25 | | | | 93 | | | | |
| B-4 | | | | 10 | 5 | | | | | | |
| B-5 | | | | | | | | 45 | | | |
| B-6 | | | | | | | | | 65 | | |
| Component C | | | | | | | | | | | |
| propylene glycol | | | 5 | | | | | | | | |
| polyethylene glycol | | 15 | 5 | | | | | | | 10 | |
| C-1 | | | | 25 | | | | 5 | | | |
| C-2 | | | | | 5 | | | | | | |

Component A

A-1: 2,5,8,11-tetramethyl-6-dodecyne-5,8-diol represented by formula (1) below

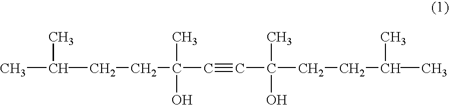

A-2: 2,5,8,11-tetramethyl-6-dodecyne-5,8-diol ethoxylate represented by formula (2) below (molar number of ethylene oxide added, m+n=6)

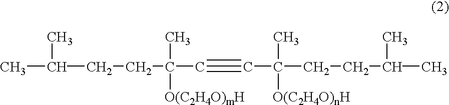

A-3: 2,5,8,11-tetramethyl-6-dodecyne-5,8-diol ethoxylate represented by formula (2) above (molar number of ethylene oxide added, m+n=50)

Component B

B-1: Epan 750 (trade name by Dai-ichi Kogyo Seiyaku Co., Ltd., HO(C₂H₄O)_{w}(C₃H₆O)₃₅(C₂H₄o)_{y}H wherein w+y=48, molecular weight 4,000, ethylene oxide content 51%, propylene oxide content 49%)

B-2: Epan 740 (trade name by Dai-ichi Kogyo Seiyaku Co., Ltd., HO(C₂H₄O)_{w}(C₃H₆O)₃₅(C₂H₄O)_{y}H wherein w+y=30, molecular weight 3,300, ethylene oxide content 39%, propylene oxide content 60%)

B-3: Epan 680 (trade name by Dai-ichi Kogyo Seiyaku Co., Ltd., HO(C₂H₄O)_{w}(C₃H₆O)₃₀(C₂H₄o)_{y}H wherein w+y=160, molecular weight 8,800, ethylene oxide content 80%, propylene oxide content 20%)

B-4: Epan 465 (trade name by Dai-ichi Kogyo Seiyaku Co., Ltd., HO(C₂H₄O)_{w}(c₃H₆O)₂₀(C₂H₄O)_{y}H wherein w+y=155, molecular weight 8,000, ethylene oxide content 85%, propylene oxide content 15%)

B-5: Epan 410 (trade name by Dai-ichi Kogyo Seiyaku Co., Ltd., HO(C₂H₄O)_{w}(C₃H₆O)₂₀(C₂H₄O)_{y}H wherein w+y=2, molecular weight 1,300, ethylene oxide content 7%, propylene oxide content 92%)

B-6: Epan 785 (trade name by Dai-ichi Kogyo Seiyaku Co., Ltd., HO(C₂H₄O)_{w}(C₃H₆O)₃₅(C₂H₄O)_{y}H wherein w+y=250, molecular weight 13,000, ethylene oxide content 84%, propylene oxide content 16%)

Component C

C-1: Surfynol 104 (trade name by Air Products and Chemicals Inc., 2,4,7,9-tetramethyl-5-decyne-4,7-diol)

C-2: Surfynol 440 (trade name by Air Products and Chemicals Inc., 2,4,7,9-tetramethyl-5-decyne-4,7-diol ethoxylate)

### Comparative Examples 7-9

Using the commercial surfactants shown below, 0.1% aqueous solutions were prepared. They were tested as in Example 1, with the results shown in Table 2. As in Example 1, ink preparations and paper coatings were prepared and tested. The results are shown in Table 3.

Product 1: Dapro W-77 (trade name by Elementis Specialties, Inc., succinate surfactant)

Product 2: KF-615 (trade name by Shin-Etsu Chemical Co., Ltd., silicone surfactant)

Product 3: Megaface F-141 (trade name by Dainippon Ink & Chemicals, Inc., fluorochemical surfactant)

TABLE 2

| | | Example | | | | | Comparative Example | | | | | | | | |
|---|---|---|---|---|---|---|---|---|---|---|---|---|---|---|---|
| | | 1 | 2 | 3 | 4 | 5 | 1 | 2 | 3 | 4 | 5 | 6 | 7 | 8 | 9 |
| Surfactant | | M-1 | M-2 | M-3 | M-4 | M-5 | M-6 | M-7 | M-8 | M-9 | M-10 | M-11 | Prod- | Prod- | Prod- |
| composition | | | | | | | | | | | | | uct | uct | uct |
| | | | | | | | | | | | | | 1 | 2 | 3 |
| Aqueous solution | | ◯ | ◯ | ◯ | ◯ | ◯ | XX Δ | X | Δ | X | XX | ◯ | ◯ | ◯ | |
| appearance | | | | | | | | | | | | | | | |
| Dynamic | @ 1 Hz | 25.7 | 28.5 | 27.4 | 27.4 | 27.2 | — | 61.3 | 49.5 | 54.5 | 52.3 | — | 44.5 | 25.5 | 24.8 |
| surface | @ 10 Hz | 31.5 | 36.0 | 33.4 | 38.8 | 34.2 | — | 68.5 | 62.3 | 62.3 | 60.9 | — | 54.8 | 41.5 | 60.4 |
| tension, | | | | | | | | | | | | | | | |
| mN/m | | | | | | | | | | | | | | | |

| | | | | | | | | | | | | | | |
|---|---|---|---|---|---|---|---|---|---|---|---|---|---|---|
| Static surface | 24.3 | 28.2 | 27.3 | 27.1 | 27.1 | — | 55.3 | 49.2 | 54.3 | 52.1 | — | 40.2 | 24.9 | 24.7 |
| tension, mN/m | | | | | | | | | | | | | | |

TABLE 3

| | Example | | | | | Comparative Example | | | | | | | | |
|---|---|---|---|---|---|---|---|---|---|---|---|---|---|---|
| | 1 | 2 | 3 | 4 | 5 | 1 | 2 | 3 | 4 | 5 | 6 | 7 | 8 | 9 |
| Ink | Ink | Ink | Ink | Ink | Ink | Ink | Ink | Ink | Ink | Ink | Ink | Ink | Ink | Ink |
| preparation | 1 | 2 | 3 | 4 | 5 | 6 | 7 | 8 | 9 | 10 | 11 | 12 | 13 | 14 |
| No. | | | | | | | | | | | | | | |
| Print plate | 10 | 10 | 10 | 20 | 10 | — | 60 | 40 | 60 | 60 | — | 60 | 50 | 70 |
| etching | | | | | | | | | | | | | | |
| depth, % | | | | | | | | | | | | | | |
| Paper | Coat | Coat | Coat | Coat | Coat | Coat | Coat | Coat | Coat | Coat | — | Coat | Coat | Coat |
| coating No. | 1 | 2 | 3 | 4 | 5 | 6 | 7 | 8 | 9 | 10 | 12 | 13 | 14 | |
| Repellency | ◯ | ◯ | ◯ | ◯ | ◯ | — | X | X | X | X | — | ◯ | ◯ | ◯ |
| Foaming, ml | 3 | 4 | 9 | 7 | 8 | — | 38 | 13 | 22 | 27 | — | 46 | 43 | 39 |

There have been described water-soluble surfactant compositions which have such surface tension-reducing effects that when added to inks and paper coatings, they provide a surface tension comparable to those of fluorochemical and silicone surfactants. Because of a low dynamic surface tension, the surfactant compositions develop excellent substrate wetting, substrate penetrating and foam suppressing capabilities to comply with high-speed printing and coating, and overcome the environmental problem. Because of these characteristics, the surfactant compositions are very advantageous in industrial applications.

Japanese Patent Application No. 2001-163378 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A water-soluble surfactant composition comprising
(A) 10 to 95% by weight of an acetylene glycol of the following formula (1): 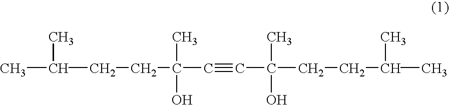
and/or an acetylene glycol ethoxylate of the following formula (2): 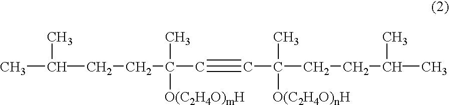
wherein m and n are positive numbers and the sum of m+n is from 2 to 30, and
(B) 5 to 90% by weight of at least one polymer selected from polyoxy(ethylene-propylene) block polymers of the following formula (3):
HO(C₂H₄O)_{w}(C₃H₆O)ₓ(C₂H₄O)_{y}H (3)
wherein w, x and y are positive numbers, having a weight average molecular weight of 1,500 to 10,000, an ethylene oxide content of 35 to 90% by weight and a propylene oxide content of 10 to 65% by weight,
the composition exhibiting a dynamic surface tension of up to 50 mN/m both at 1 Hz and 10 Hz in a 0.1 wt % aqueous solution thereof.

2. The composition of claim 1 wherein in formula (2), m+n is from 4 to 12.

3. The composition of claim 1 which contains 40 to 70% by weight of component (A) and 5 to 50% by weight of component (B).

4. The composition of claim 1 wherein component (B) is selected from polyoxy(ethylene-propylene) block polymers represented by the following formulae:
HO(C₂H₄O)_{w}(C₃H₆O)₂₀ (C₂H₄O)_{y}H wherein w+y=27,
HO(C₂H₄O)_{w}(C₃H₆O)₃₀(C₂H₄O)_{y}H wherein w+y=160,
HO(C₂H₄O)_{w}(C₃H₆O)₃₅(C₂H₄O)_{y}H wherein w+y=30,
HO(C₂H₄O)_{w}(C₃H₆O)₃₅(C₂H₄O)_{y}H wherein w+y=48, and
HO(C₂H₄O)_{w}(C₃H₆O)₂₀(C₂H₄O)_{y}H wherein w+y=155.

5. The composition of claim 1 further comprising (C) up to 25% by weight of a component selected from the group consisting of water, water-soluble organic solvents, and acetylene glycols and ethoxylates thereof other than formulae (1) and (2).

6. The composition of claim 1 which exhibits a dynamic surface tension of 10 to 50 mN/m both at 1 Hz and 10 Hz in a 0.1 wt % aqueous solution thereof.
